(19) United States
(12) Patent Application Publication
(10) Pub. No.: US 2024/0049161 A1
(43) Pub. Date: Feb. 8, 2024

(54) METHODS AND PROCEDURES FOR MULTI-STA ASSISTED SENSING

(71) Applicant: INTERDIGITAL PATENT HOLDINGS, INC., Wilmington, DE (US)

(72) Inventors: Satyanarayana Katla, London (GB); Onur Sahin, London (GB); Rui Yang, Greenlawn, NY (US); Sanjay Goyal, Deer Park, NY (US); Mihaela Beluri, Jericho, NY (US); Arnab Roy, Phoenixville, PA (US)

(73) Assignee: INTERDIGITAL PATENT HOLDINGS, INC., Wilmington, DE (US)

(21) Appl. No.: 18/266,328

(22) PCT Filed: Dec. 14, 2021
(86) PCT No.: PCT/US2021/063298

§ 371 Date: Jun. 9, 2023

Related U.S. Application Data
(60) Provisional application No. 63/125,263, filed on Dec. 14, 2020.

(51) Int. Cl. H04W 64/00; G01S 13/04; G01S 7/00

(52) U.S. Cl. CPC H04W 64/00; G01S 13/04; G01S 7/006

(57) ABSTRACT

Methods and apparatuses for sensing a cluster of closely-spaced objects are described herein. A method implemented in a first station (STA) may include receiving, from a second STA, a multicast message including information indicating a request for one or more STAs to participate in a sensing procedure and information indicating one or more sensing parameters. The method may include transmitting, to the second STA, an indication that the first STA is capable of participating in the sensing procedure based on the one or more sensing parameters, the indication including information associated with a participation ability of the first STA. The method may include receiving, from the second STA, configuration information for performing the sensing procedure sensing as a transmit responder based on the information associated with the participation ability of the first STA, and performing the sensing procedure as the transmit responder by transmitting beamformed signals.

### CROSS-REFERENCE TO RELATED APPLICATIONS

This application claims the benefit of U.S. Provisional Application No. 63/125,263 filed Dec. 14, 2020; the contents of which are incorporated herein by reference.

### BACKGROUND

Joint radar and communication systems may be considered in solutions to the ever-increasing demand for spectrum, which may be due to services with high bandwidth requirements and exponential increases in the number of connected devices that systems support. Joint systems may allow radar and communication systems to operate in the same bandwidth without causing excessive interference between each other.

### SUMMARY

Methods and apparatuses for sensing a cluster of closely-spaced objects are described herein. A method implemented in a first station (STA) may include receiving, from a second STA, a multicast message including information indicating a request for one or more STAs to participate in a sensing procedure and information indicating one or more sensing parameters. The method may include transmitting, to the second STA, an indication that the first STA is capable of participating in the sensing procedure based on the one or more sensing parameters, the indication including information associated with a participation ability of the first STA. The method may include receiving, from the second STA, configuration information for performing the sensing procedure as a transmit responder based on the information associated with the participation ability of the first STA, and performing the sensing procedure as the transmit responder by transmitting beamformed signals.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 is a system model illustrating spatial relationships between beams as seen from devices at different locations;

FIG. 3 is a flowchart illustrating steps as may be performed in a sensing procedure;

FIG. 4 is another flowchart illustrating steps as may be performed in a sensing procedure;

FIG. 5 is a system model illustrating participant devices of a sensing procedure according to some embodiments;

FIG. 6 is a flowchart illustrating procedures as may be performed by a sensing initiator;

FIG. 7 is a flowchart illustrating procedures as may be performed by a sensing responder;

FIG. 8 is a schematic illustrating signaling procedures between a device acting as sensing initiator and one or more devices acting as sensing responders;

FIG. 9 illustrates an example procedure for multicast coordination for sensing; and

FIG. 10 illustrates an example procedure for unicast coordination for sensing.

### DETAILED DESCRIPTION

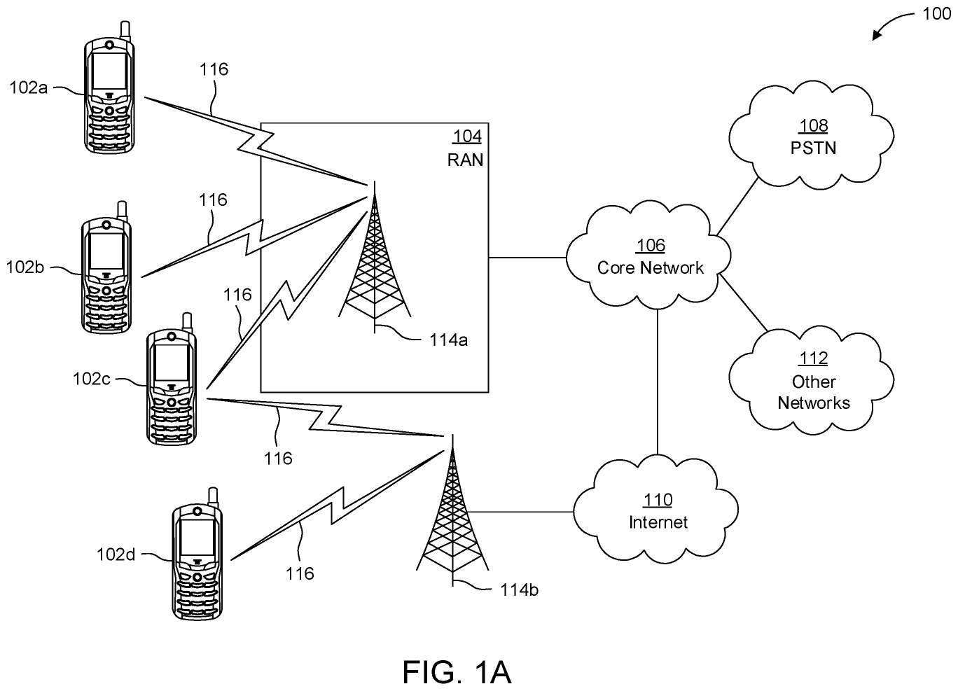

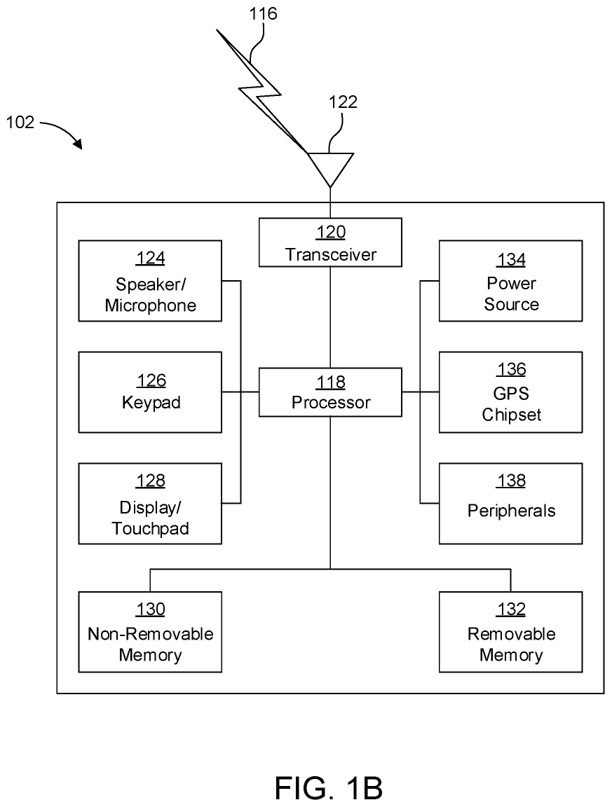

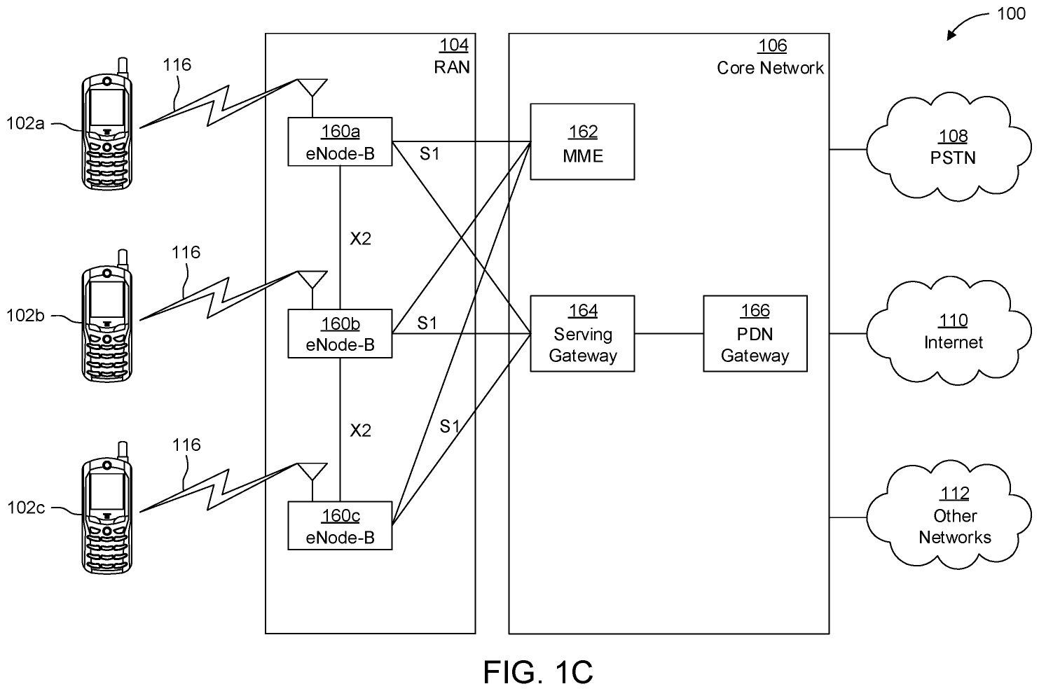

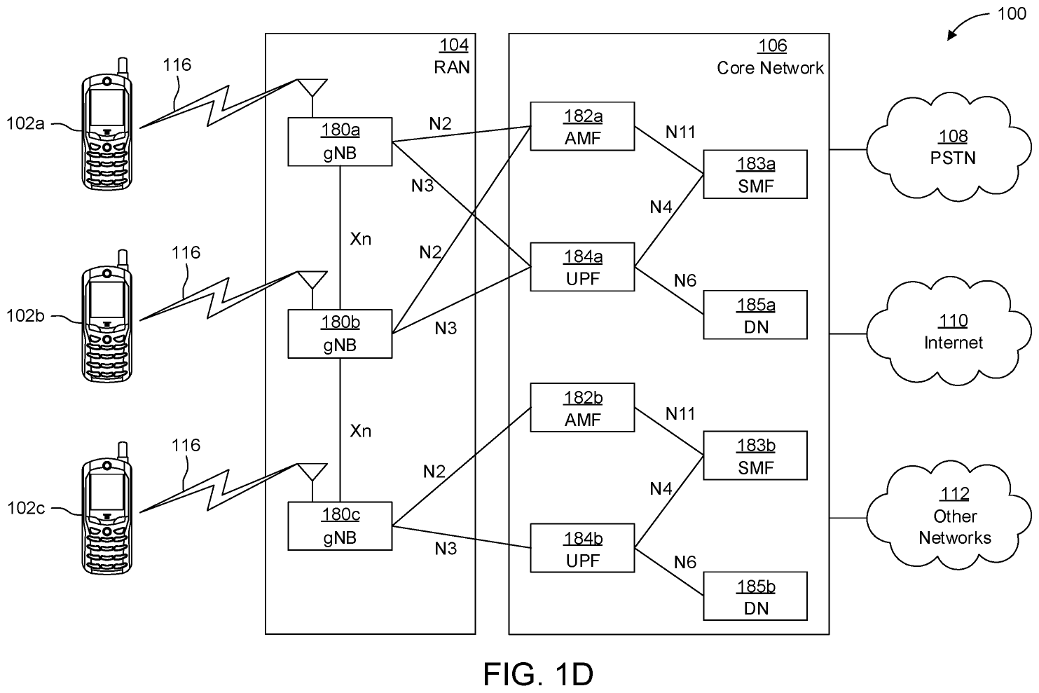

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (STA), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a NodeB, an eNode B (eNB), a Home Node B, a Home eNode B, a next generation NodeB, such as a gNode B (g NB), a new radio (NR) NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using NR.

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a g NB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or WiFi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz, and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode) transmitting to the AP, all available frequency bands may be considered busy even though a majority of the available frequency bands remains idle.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 104 and the CN 106 according to an embodiment. As noted above, the RAN 104 may employ an NR radio technology to communicate with the WTRUs 102a, 102b, 102c over the air interface 116. The RAN 104 may also be in communication with the CN 106.

The RAN 104 may include gNBs 180a, 180b, 180c, though it will be appreciated that the RAN 104 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement M IMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, DC, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 106 shown in FIG. 1D may include at least one AMF 182a, 182b, at least one UPF 184a,184b, at least one Session Management Function (SMF) 183a, 183b, and possibly a Data Network (DN) 185a, 185b. While the foregoing elements are depicted as part of the CN 106, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and the like. The AMF 182a, 182b may provide a control plane function for switching between the RAN 104 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 106 via an N11 interface. The SMF 183a, 183b may also be connected to a UPF 184a, 184b in the CN 106 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 104 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering DL packets, providing mobility anchoring, and the like.

The CN 106 may facilitate communications with other networks. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Embodiments described herein may focus on multicarrier joint radar and communication solutions using an underlying wireless system, such as a Wireless Local Area Network (WLAN), in which the wireless system is enabled with sensing capabilities. Such capabilities may include detecting the presence of people, monitoring the well-being of a person, localization of a person/device (coarse/fine), measuring the velocity of a moving object, or detecting obstacles.

Key metrics used for quantifying sensing performance may include a received signal strength (RSS) indicator (RSSI), channel state information (CSI), angular resolution, range resolution, phase shift, and time-of-flight (ToF), among others. Solutions that may be adopted or implemented in technologies operating in accordance with various standards such as 802.11 SENS may focus on the CSI metric since CSI provides finer granularity, while other metrics (e.g. RSS and ToF) may provide coarser measures of detection.

One of the key challenges addressed by state-of-the art radar communication-based techniques for sensing may be the inability to discriminate between the activity of the closely spaced objects. Since some techniques may consider variations in the metrics such as the CSI, the RSS, or ToF, the number of objects that can be detected may be strictly limited if the metrics are correlated or approximately similar to each other. This may become extremely challenging when the objects or individuals that need to be identified are closely spaced. This may be because the CSI/RSS/ToF associated with the objects may be highly correlated. Therefore, a single sensing-enabled device may not be able to discriminate between the activities of the objects that experience correlated fading. Furthermore, the resolution of the CSI for measuring the variations arising from the motion due to the Doppler effect, which may be used for identifying the motion/location of the object, may also be dependent on bandwidth. Embodiments described herein may involve methods and procedures for discriminating between closely spaced objects. Such methods and procedures may rely on, for example, multiple sensing responders as well as additional means for enhancing the bandwidth used in the sensing process.

In the paragraphs above and below, terminology as used in standards developed by the Institute of Electrical and Electronics Engineers (IEEE), for instance, the 802.11bf Task Group, may be used. However, procedures proposed herein may be applicable to other wireless systems and standards. Methods provided herein may be described with reference to AP-STAs that may perform various sensing operations. The sensing procedures provided in this disclosure may be performed by AP-STAs and/or non-AP-STAs. It should also be noted, however, that devices that may carry out methods or procedures described herein, or portions of such methods or procedures are not limited to AP-STAs or non-AP-STAs. Embodiments described herein may make reference to devices generally, which may act as “sensing initiators,” “sensing responders,” “potential sensing responders,” “initiators,” or “responders.” A sensing initiator or initiator as described herein may be referred to interchangeably as a STA, an AP, an AP-STA, a non-AP-STA, a wireless device (or simply, “a device”), a wireless sensing device, a WTRU, a UE, a base station, or a network node. Similarly, a sensing responder or responder may be referred to interchangeably as a STA, an AP, an AP-STA, a non-AP-STA, a wireless device (or simply, “a device”), a wireless sensing device, a WTRU, a UE, a base station, or a network node.

In some embodiments provided herein, a sensing initiator may be a device (e.g., a STA, an AP, an AP-STA, a non-AP-STA, a wireless device (or simply, “a device”), a wireless sensing device, a WTRU, a UE, a base station, or a network node) that initiates a sensing session or procedure, while a sensing responder may be a device that participates in a sensing session or procedure (e.g., for sensing within a WLAN or other wireless network) initiated by the sensing initiator. In some examples consistent with industry standards such as 802.11bf, a sensing session may correspond to an instance of a sensing procedure with the associated scheduling if applicable, and operational parameters of that instance. During a sensing session or procedure, a sensing responder may be a sensing transmitter or sensing receiver. A sensing transmitter may be a device that transmits signals (e.g., PPDUs) used for sensing measurements in a sensing session or procedure, while a sensing receiver may be the device that receives such signals or transmissions (e.g., PPDUs) sent by a sensing transmitter and performs sensing measurements

A device that participates in a sensing session or procedure as a sensing initiator may be a sensing transmitter, a sensing receiver, or both a sensing transmitter or a sensing receiver. In other words, a sensing initiator may transmit sensing signals, receive sensing signals, or both transmit and receive sensing signals. A device that participates in a sensing session or procedure as a sensing initiator may also be capable of participating in sensing sessions or procedures as a sensing responder.

A device that participates in a sensing session or procedure as a sensing responder may be transmit (Tx) responder, a receive (Rx) responder, or both. In some embodiments, a device may be capable of participating in a sensing session or procedure transmit (Tx) responder, a receive (Rx) responder, or both, but may not actually participate in a particular sensing session or procedure, for example, if the device is unable to meet requested or required transmission or reception parameters, as is discussed in further detail in paragraphs below. In some embodiments, a device may participate as either a Tx responder or an Rx responder, despite being capable of participating in sensing sessions or procedures as both a Tx responder and an Rx responder. In some embodiments, a device may participate in a sensing procedure as a Tx responder, an Rx responder, or as both, based on a location of the device relative to other devices that have been requested to participate in the sensing session or procedure, or based on a location of the device relative to a detected cluster. Similarly, a device may not participate in a sensing procedure at all based on a location of the device relative to other devices that have been requested to participate in the sensing session or procedure, or based on a location of the device relative to a detected cluster.

Sensing devices may be monostatic, bistatic or multi-static. In monostatic devices, both transmitter and receiver may be present within the same node. In bistatic receivers, the transmitter and receiver may be embodied in different nodes. In multi-static receivers, there may be multiple transmitters and multiple receivers located at different nodes. Systems in which multi-static sensing is implemented may include, for example, both monostatic and bistatic devices, which in combination provide for robustness in terms of spatial diversity among transmitters and receivers.

Devices as described herein may have any of the capabilities described above. For example, a device may be monostatic and have full duplexing capability. Some or all devices may enabled with sensing features and may act as a sensing initiator or responder. Although the embodiments in this disclosure may directly consider monostatic devices, (i.e., sensing initiators and/or responders may act as a transmitter and/or receiver), the methods and procedures presented in this disclosure may be extended to bistatic/multi-static devices.

Sensing may be performed using beamforming, such that devices may decide to perform sensing by beam sweeping (e.g., by sequentially sensing in multiple predefined directions over a regular interval) or by sensing using a beam in a specific direction. For instance, a sensing initiator may request that a sensing responder steer the beam in a specific direction. In such scenarios, the device that transmits sensing signals may transmit one or multiple sensing signals in one or multiple beams, and upon reception of the resulting reflected or scattered signals, a sensing responder may detect a cluster based on measurements (e.g., ToF measurements), where the cluster can include a single individual/object, a group of individuals or inanimate objects.

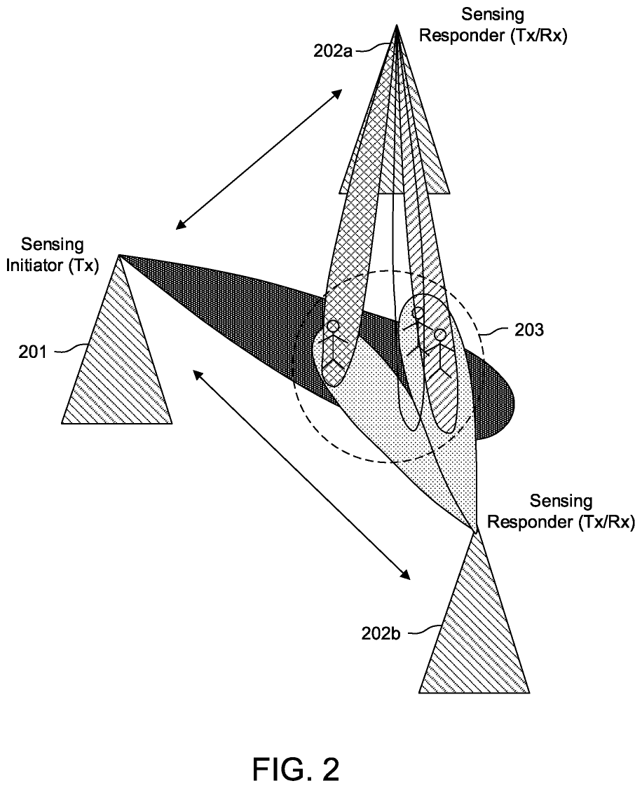

FIG. 2 is a system model illustrating spatial relationships between beams as seen from devices at different locations. As shown in FIG. 2, a system may at least include a sensing initiator 201, a sensing responder 202a and a sensing responder 202b. The sensing initiator 201 and the sensing responders 202a and 202b may be located in, or within proximity of, an area 203 in which one or multiple objects or clusters of objects may be located. The sensing initiator 201 and/or the sensing responders 202a and/or 202b may be configured to sense such obstacles using beamforming (e.g., using beam sweeping or by steering a beam in a specific direction). For instance, the sensing initiator may transmit one or multiple sensing signals in one or more beams directed in one or multiple spatial directions. The sensing responders 202a and/or 202b may receive the one or multiple sensing signals transmitted by the sensing initiator 201, for instance, when reflected off of the cluster shown in the area 203. The sensing responders 202a and/or 202b may use beamforming techniques to receive the reflected sensing signals. In some embodiments as shown in FIG. 2, the beams used by the sensing initiator 201 for transmission of the sensing signal may be wider than the beams used to receive the reflected sensing signals. In addition to detecting the one or multiple sensing signals transmitted by the sensing initiator 201, the sensing responders 202a and/or 202b, having both transmit (Tx) and receive (Rx) capabilities, may be capable of transmitting sensing signals themselves and/or sensing their own transmitted sensing signals in addition to the detecting sensing signals transmitted by other devices. In some embodiments not shown, the sensing responders may be capable only of transmitting said sensing signals.

Embodiments described herein may contemplate technical shortcomings and challenges in state-of-the-art wireless sensing and communication solutions. The embodiments descried herein may be implemented in accordance with, for example, 802.11 SENS, particularly in resolving ambiguity resulting from correlated CSI/RSS/ToF sensing metrics observed among objects or individuals within a cluster.

In some examples, within the same sector/beam coverage, a metric (e.g., CSI/RSS/ToF) determined for two or more of the closely spaced objects (i.e., whose separation (d) between them may be less than c/2B, where c represents the speed of light and B represents the signal bandwidth, may be highly correlated. This may result in ambiguity in the identification of objects as well as in activity/motion detection.

Sensing resolution for activity/motion detection may be contingent on bandwidth. Existing solutions for indoor sensing may not consider bandwidth aggregation by providing coordination among multiple devices for improving sensing accuracy. As such, methods and procedures for multi-device assisted sensing, where multiple devices (i.e., sensing responders) participate in the sensing either sequentially or in a simultaneous manner for discriminating between closely spaced objects, may be disclosed herein. Some proposed techniques may allow a sensing initiator to identify these correlated objects, despite their similar CSI/RSS/ToF. Proposed techniques may also provide for improvements to the sensing resolution of an object/individual using one or multiple sensing responders that act as either Tx responders or Rx responders.

Some solutions may provide for coordination among multiple devices for discriminating between the closely-spaced objects, and such coordination may be facilitated by leveraging the channel (e.g. beam pairs, CSI) observed by other devices, since CSI acquired from other nodes may not be correlated. This may be akin to diversity in communications. Some solutions may provide for bandwidth granting among multiple devices for improving sensing resolution (i.e., bandwidth aggregation by coordinating with multiple devices for improved sensing).

Procedures for multi-device assisted sensing are described herein. In such solutions, multiple devices may participate in sensing sequentially or in a parallel manner with the objective of improving the sensing resolution as well as discriminating between the closely spaced objects. Proposed techniques may allow a sensing initiator to identify the correlated objects, which may indicate approximately similar CSI/RSS/ToF, and/or to improve the sensing resolution, using multiple sensing responders acting as either Tx or Rx responders.

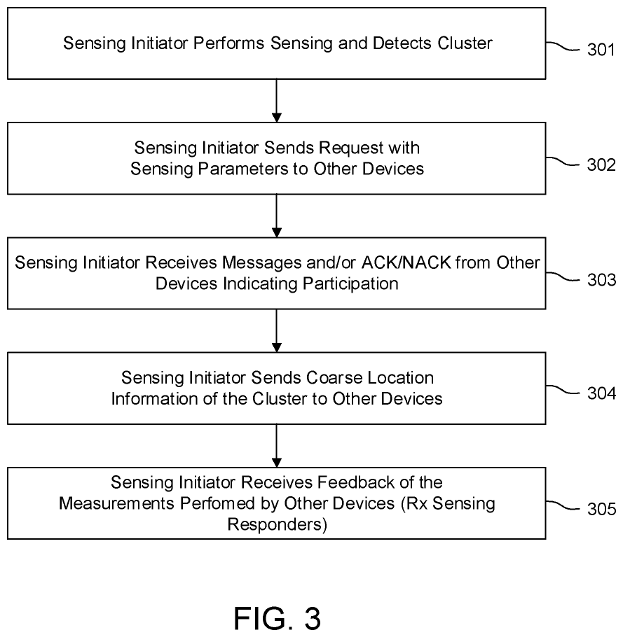

FIG. 3 is a flowchart illustrating steps as may be performed in a sensing procedure. One or more steps of a procedure according to some proposed designs may be performed by a sensing initiator as follows. As shown at 301, a sensing initiator may detect a cluster that may include multiple correlated objects. The sensing initiator may sense the cluster, for example, by transmitting and receiving sensing signals using beam sweeping methods as described substantially in paragraphs above. The detection of the sensing signals may be based on, for instance, a time-of-flight of received sensing signals.

As shown at 302, the sensing initiator may send a request frame with information indicating required or requested sensing parameters to one or more devices. Such request and/or sensing parameters may be sent, for example, when the sensing initiator decides to improve the sensing resolution (e.g., in order to discriminate between the multiple correlated objects of the detected cluster). The sensing session requirements may include a sensing resolution and/or a sensing duration.

As shown at 303, the sensing initiator may receive a message or messages from devices to which the sensing session requirements were indicated, and such messages may indicate whether the respective devices are able to participate as Tx sensing responders, Rx sensing responders, or as both Tx sensing responders and Rx sensing responders. In embodiments not depicted in FIG. 3, the message or messages may indicate that, based on the information in the request frame sent by the sensing initiator the devices are not able to participate in the sensing session.

As shown at 304, the sensing initiator may send coarse location information of the cluster, for instance, to devices that indicated they are capable of participating in the sensing procedure as sensing responders. The coarse location information may include information such as the beam direction, beam identification information, beam refinement duration, or other information associated with the cluster location.

Though not shown in FIG. 3, in some embodiments the sensing initiator may receive a request or requests from devices capable of participating in the sensing procedure for time and/or frequency resources (e.g., additional bandwidth) to be allocated for the sensing procedure. The sensing initiator may send an ACK/NACK and/or a message to the sensing responder or responders from which the requests were received, and the message may indicate configuration information for performing the sensing procedure. For instance, the configuration information may indicate time and/or frequency resources, such as a duration for access to a frequency resource used for sensing, (e.g., access to the bandwidth portion or portions used for the sensing procedure).

As shown at 305, the sensing initiator may receive feedback from the sensing responders. The feedback may include measurements of signals observed by each of the sensing responders (i.e., sensing responders that participated in the sensing procedure as Rx responders). The sensing initiator may interpret the measurements to identify objects of the cluster.

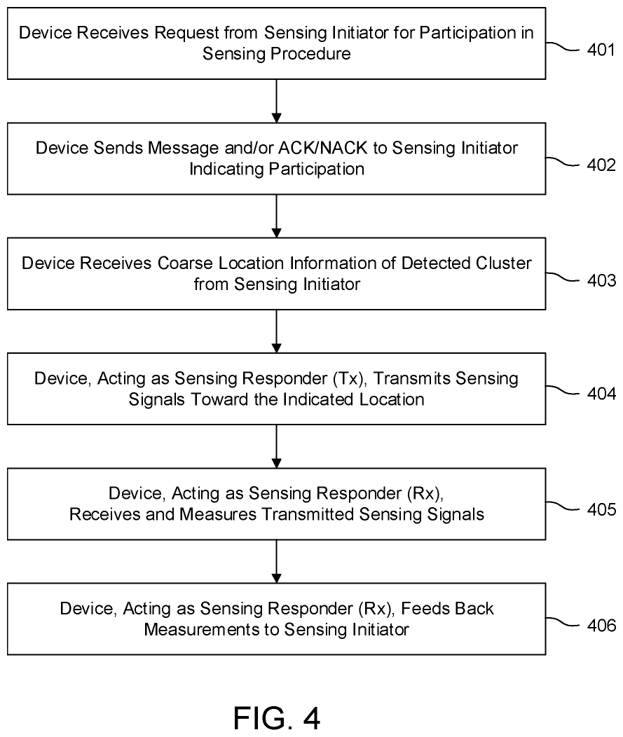

FIG. 4 is another flowchart illustrating steps as may be performed in a sensing procedure. A procedure according to some proposed designs may be performed by a device, which may determine to act as a sensing responder, as follows. As shown at 401, a device may receive a request from a sensing initiator for participation in a sensing procedure, for example, to identify or otherwise sense objects of a detected cluster. The request may include requested or required parameters to be used for the sensing procedure, such as a sensing resolution and/or a sensing duration.

As shown at 402, the device may send a message indicating whether the device is capable of participating in the sensing procedure as a Tx sensing responder, an Rx sensing responder, or as both a Tx and an Rx sensing responder. In embodiments not depicted in FIG. 4, the message may indicate that, based on the information in the request frame sent by the sensing initiator, the respective devices are not able to participate in the sensing session.

As shown at 403, the device may receive an indication of coarse location information of the detected cluster. The coarse location information may include information such as the beam direction, beam identification information, beam refinement duration, or other information associated with the cluster location.

In embodiments not shown in FIG. 4, a device that determines and indicates to the sensing initiator that it is capable of participating in the sensing procedure as a sensing responder and may send a request to the sensing initiator for time and/or frequency resources (e.g., additional bandwidth) to be allocated for the sensing procedure. The device/sensing responder may receive a message from the sensing initiator with configuration information indicating time and/or frequency resources, such as a duration for access to a frequency resource used for sensing, (e.g., access to the bandwidth access portion or portions used for the sensing procedure).

In some embodiments as shown at 404, the device, acting as Tx sensing responder, may transmit PPDUs towards the location as requested by the sensing initiator for additional signal observation in order to decorrelate the channel. In some embodiments as shown at 405, the device, acting as an Rx sensing responder, may measure the signal scattered or reflected off the target. As shown at 406, the device may then feedback the measurements to the sensing initiator. It should be appreciated that in embodiments in which the device is not capable of participating as a Tx sensing responder, the device may not perform step 404. It should also be appreciated that in embodiments in which the device is not capable of participating as an Rx sensing responder, the device may not perform steps 405 or 406.

Described herein are further procedures for coordinated sensing. Initially, a sensing initiator may perform sensing operations by transmitting sensing signals (e.g., utilizing beam sweeping techniques with a predetermined angle of arrival and departure (AoA-AoD) pattern) to identify clusters or obstacles in each AoA-AoD pair. Such clusters or objections may include animate or inanimate objects, and each cluster may have a single object or multiple objects. The clusters may be identified based on, for example, the ToF of the transmitted sensing signals, CSI profiling, or other metrics.

In embodiments involving a mono-static sensing initiator, the sensing initiator may be capable of both transmitting sensing signals and receiving sensing signals (i.e., the sensing initiator may both a Tx sensing initiator and an Rx sensing initiator. The initiator may be able to detect clusters based on the sensing measurements (e.g. ToF, CSI variations) on the reflected signal (PPDUs). In embodiments involving a bi/multi-static sensing initiator, the sensing initiator may only be capable of performing as a Tx responder and may transmit PPDUs that are received by one or multiple sensing responders to perform sensing measurements.

When a cluster (which may include a single object or multiple objects) is detected, and if the sensing initiator desires to discriminate between the multiple correlated objects, or improve its sensing resolution of a particular object/individual or to determine whether is multiple objects are located within the detected cluster or not, then the sensing initiator may send requests to other devices that may be located at different locations to act as sensing responders. The sensing initiator may include requested or required sensing parameters (e.g. resolution) needed to resolve the objects.

In some embodiments, the sensing initiator may only need to know if a cluster exists or whether an object is mobile or static. In such cases, a sensing initiator may not send a request to other devices.

In some options, a network node (or any other node within the wireless network or system in which the sensing initiator operates) may request that devices sense in a particular location or sense a previously detected object with a desired resolution. The location may be identified based on an initial set of sensing measurements performed by the sensing initiator or another network node. In such cases, the sensing initiator may send this location information to other devices (i.e., potential sensing responders) for improving the sensing resolution.

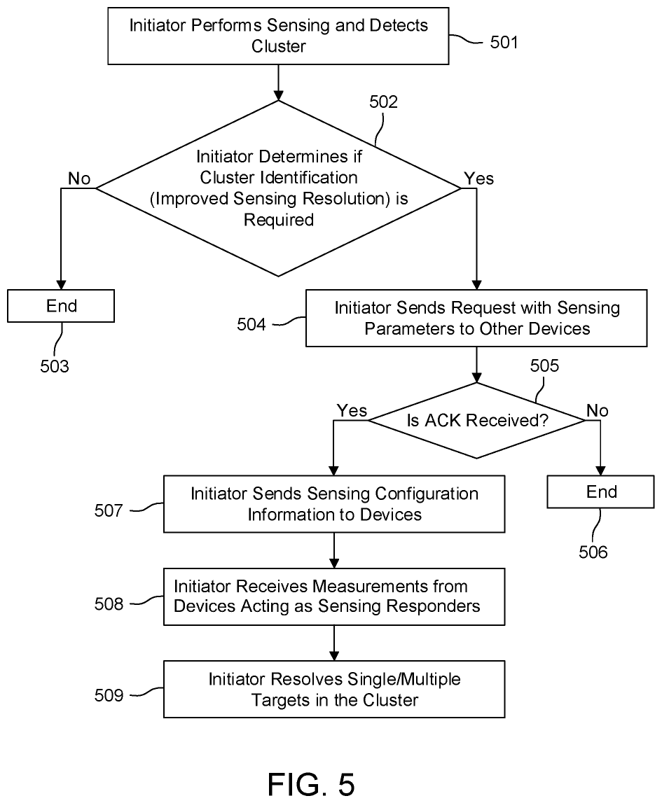

FIG. 5 is a system model illustrating participant devices of a sensing procedure according to some embodiments. As shown in FIG. 5, a system may at least include a network/system node 501, a sensing initiator 502, a sensing responder 503a and a sensing responder 503b. The network/system node 501 may be a network node or system node within the wireless network or system in which the sensing initiator operates. The network/system node 501 and the sensing initiator 502 may interface, for example, wirelessly or via a backhaul wired connection. The sensing initiator 502 and the sensing responders 503a and 503b may be located in, or within proximity of, an area 504 in which one or multiple objects or clusters of objects may be located. The network/system node 501 may be aware of sensing measurements previously performed, e.g., by the sensing initiator or another node or device and may desire to obtain sensing information at a higher desired resolution within a particular location, 504. The sensing initiator 502, having become aware that sensing at a given resolution is desired at the location 504, may, in some circumstances, send this location information to devices such as the sensing responder 503a and 503b to facilitate a sensing procedure at the location 504. For example, the sensing initiator 502 may request devices to participate in a sensing procedure at the desired resolution. Having established that sensing responder 503a and 503b are to participate in the sensing procedure as both Tx and Rx sensing responders, the sensing initiator 502 may forward the location information indicated by the network/system node 501 to the sensing responders 503a and 503b for use in a sensing procedure as may be performed according to any of the embodiments as are described herein. The sensing responders 503a and 503b may perform measurements at the desired resolution and feed back the measurements to the sensing initiator 502, which may then provide the requested sensing measurements to the network/system node 501.

In some scenarios, devices may already be performing sensing (i.e., taking measurements of sensing signals) for their own purposes and not necessarily in coordination with other sensing devices. A sensing initiator or sensing responder may send a request to other devices requesting that they provide their latest measurement results. A request for measurement results may call for additional information certain conditions (or no conditions at all) such as an indication of a time stamp, duration, or period in which the measurement was made, direction information, type of measurement, or other information. Alternatively, or additionally, a request for measurement results may be sent for measurements performed within a certain time frame or duration, a certain direction, or for measurements of a certain type.

An initiator may send sensing parameters (e.g. resolution, sensing duration, sensing accuracy, location information, etc.) to other devices, to enable the other devices to participate in sensing. Other devices may initially check data transmission parameters (e.g. SNR, rate, transmit beam angle), to determine whether the devices are capable of performing the procedure with the requested sensing parameters (e.g. resolution, sensing duration, sensing accuracy, or location information). The devices may each send a message to the initiator indicating whether the respective device is able to participate as a Tx sensing responder, Rx sensing responder, or both, or whether the AP-STA will not participate in the sensing session. The messages indicating the capabilities of the devices may include or be sent along with ACK/NACK messages.

In some embodiments, if a requested or required sensing resolution (e.g., a sensing resolution threshold or a minimum sensing resolution) may not be met then the devices that sent messages and/or ACK/NACK messages indicating they may act as responders may request additional bandwidth for use by these devices in the sensing procedure. A sensing initiator may send an ACK/NACK message to the devices that requested additional bandwidth. In some cases, if the ACK message is sent, then the sensing initiator may grant additional bandwidth. The ACK message may include configuration information for the bandwidth grant related to the sensing procedure, such as a granted band, duration of the grant, and/or other parameters. If the additional bandwidth granted by the sensing initiator to the sensing responder in order to achieve the desired sensing resolution is also not sufficient, then other sensing responders may participate in sensing, and the other sensing responders may also grant their bandwidth to the sensing responder that requested the additional bandwidth.

In some embodiments, when a sensing initiator identifies responders that have sent an ACK to participate in the sensing session, the sensing initiator may send sensing configuration information to the sensing responders that have agreed to participate in the sensing session as transmitters. The configuration information may include sensing parameters, a multiplexing type (such as a time/frequency/space for each sensing responder to transmit a null data packets (NDPs) or PPDUs (e.g., joint communication and sensing (JCS) PPDUs) for sensing, a resource unit (RU) or RUs on which the sensing measurements can be fed-back, or other parameters. Sensing responders that act as Tx responders may transmit PPDUs in the indicated location using beam-sweeping techniques. For example, the Tx responders may transmit PPDUs in the coarse location using narrow beams to obtain additional measurement information to be used for channel decorrelation.

In some embodiments, a device acting as Tx responder may commence beam sweeping using a broad beam, and if the sensing resolution is still below a desired level (e.g., below a threshold), the Tx responder may perform additional beam-refinement and beam-sweeping procedures (e.g., using narrower beams). The duration of such beam refinement procedures may be provided for (i.e., granted) by the sensing initiator for example, in a sensing request or other sensing configuration message.

In embodiments involving mono-static devices, the same sensing responder may acts as an Rx responder for performing measurements (e.g. Doppler values or CSI measurements). In embodiments involving multi-static devices, sensing responders may act as Rx responders for performing measurements for the measurement signals transmitted by the devices that sent ACKs to the sensing initiator. In unicast scenarios involving multi-static devices, if one sensing responder has already achieved the requested sensing resolution or target key performance indicator (KPI), then that sensing responder or the sensing initiator may inform other sensing responders that participate in the sensing to cease or terminate the sensing operation. In multicast scenarios involving multi-static devices, the sensing responders may act in a cooperative manner and report sensing measurement outcomes to the sensing initiator. Decision making (e.g., detection and/or identification of the cluster or object within the cluster, or other processes) may be performed at this node centrally.

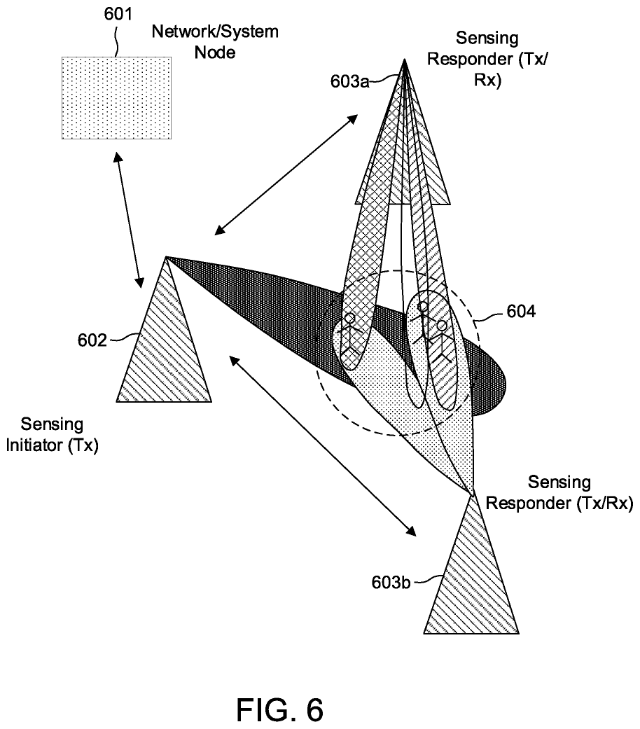

FIG. 6 is a flowchart illustrating procedures as may be performed by a sensing initiator. As shown at 601, a sensing initiator may perform sensing using beam sweeping techniques substantially as described in paragraphs above. The sensing initiator may detect a cluster (containing one or multiple objects or obstacles). At 602, the sensing initiator may determine whether an improvement in sensing resolution is desirable or required, for example, to identify the detected cluster or to identify the objects or obstacles within the detected cluster. If not, at 603, the sensing initiator may end the procedure. If cluster identification or improvements to sensing resolution are required, at 604, the sensing initiator may send a request including sensing parameters to other devices. At 605, the sensing initiator may monitor for responses from the other devices. If the sensing initiator does not receive responses from the other devices, the sensing initiator may end the procedure, as shown at 606. If the sensing initiator receives responses from other devices, at 607, the sensing initiator may send sensing configuration information to the devices. At 608, the sensing initiator may receive feedback including measurements from devices participating in the sensing procedure as sensing responders. The initiator may, at 609, discriminate between objects or obstacles in the cluster by resolving a single target or multiple targets in the cluster.

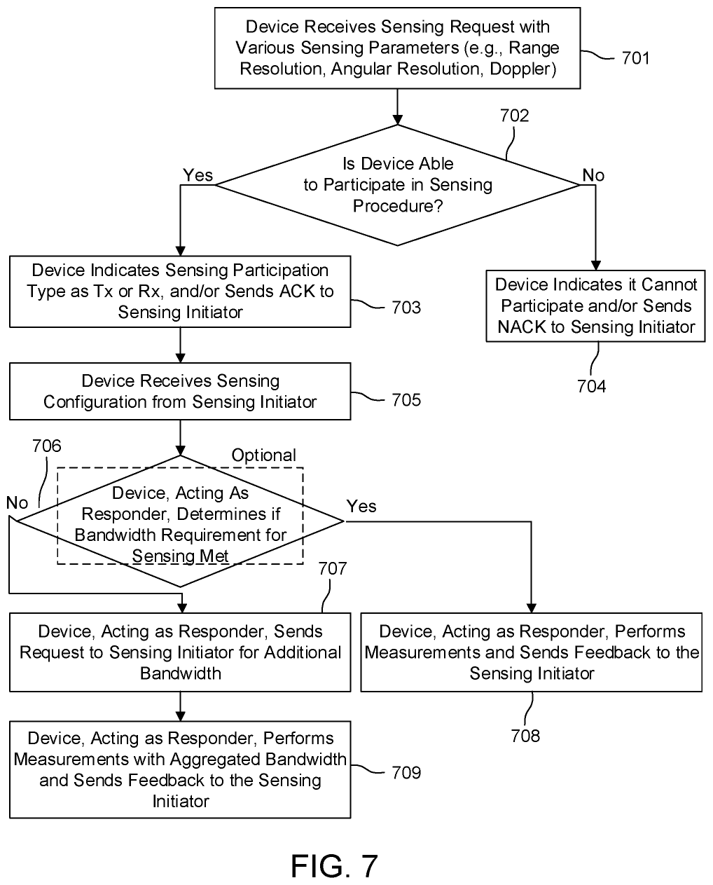

FIG. 7 is a flowchart illustrating procedures as may be performed by a sensing responder. As shown at 701, a device may receive a request for participation in a sensing procedure including requested or required sensing parameters (such as a range resolution, angular resolution, or Doppler). At 702, the device may determine whether data transmission requirements are met. If not, at 704, the device may respond to the sensing initiator, e.g., with NACK and/or a message indicating the device is not capable of participating in the sensing procedure. If the data transmission requirements are met, at 703, the device may send an ACK and/or a message indicating it is capable of participating in the sensing procedure as one or both of a Tx sensing responder or an Rx sensing responder. At 705, the device receives sensing configuration information from the sensing initiator. In some embodiments as shown at 706, the device may determine whether a bandwidth requirement for sensing is met. If not, at 707, the device sends a request to the sensing initiator for additional bandwidth before, at 709, performing measurements with aggregated bandwidth (e.g., including additional bandwidth granted by the sensing initiator or other sensing responders) and sending feedback including the measurements to the sensing initiator. If a bandwidth requirement for sensing is met, as shown at 708, the device may perform measurements without requesting additional bandwidth and send feedback to the sensing initiator including the measurements.

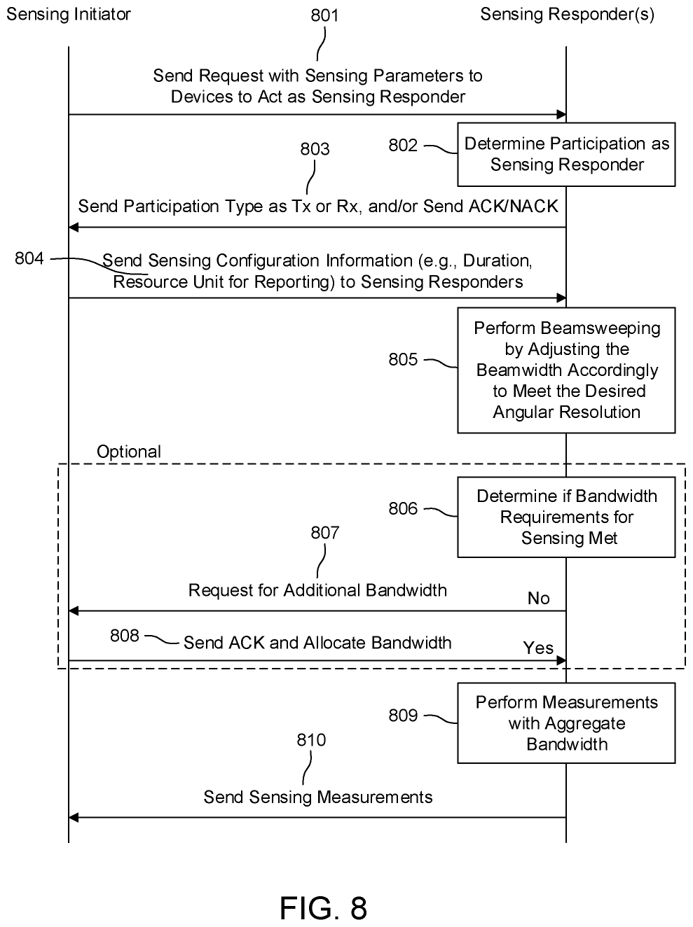

FIG. 8 is a schematic illustrating signaling procedures between a device acting as sensing initiator and one or more devices acting as sensing responders. As shown at 801, a sensing initiator may send a request to one or more devices to act as sensing responders. The request may include requested or required sensing parameters for the sensing procedure. At 802, each of the devices that received the request may evaluate whether the requested or required parameters are may be met and determine whether each may participate in the sensing procedure as a Tx responder, as an Rx responder, or as both a Tx responder and an Rx responder. At 803, the devices may send messages to the sensing initiator acknowledging the request and either indicating their participation type or indicating that they are unable to participate in the sensing procedure based on the requested or required sensing parameters. At 804, the sensing initiator may send sensing configuration information (such as a sensing duration, resources for reporting measurements, etc.) to the devices. At 805, devices acting as Tx responders may transmit sensing signals using beam sweeping techniques (substantially as described in paragraphs above), by adjusting a beam width to meet the desired angular resolution.

Optionally, in some embodiments as shown at 806, devices acting as sensing responders may determine whether a bandwidth requirement for sensing is met. If not, at 807, devices may send requests to the sensing initiator for additional bandwidth and, at 808, receive messages from the sensing initiator acknowledging the request and allocating additional bandwidth. performing measurements with aggregated bandwidth (e.g., including additional bandwidth granted by the sensing initiator or other sensing responders) and sending feedback including the measurements to the sensing initiator.

As shown at 809, device meeting the bandwidth requirements may receive and perform measurements on reflected or scattered sensing signals. At 810, the devices acting as sensing responders may send feedback to the sensing initiator including their respective measurements.

Embodiments directed to multi-device coordination are described herein. As described substantially above, a sensing initiator may be responsible for all sensing configurations of the sensing responders. Furthermore, as described substantially above, a sensing initiator may send configuration information to sensing responders in a multicast manner or in a unicast manner.

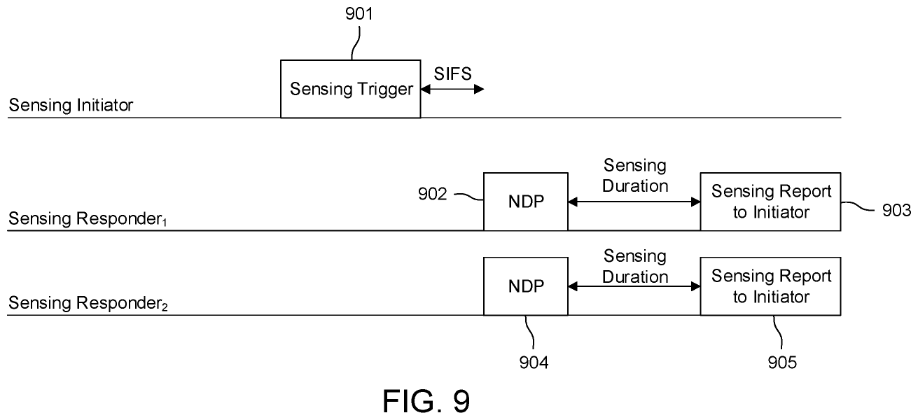

FIG. 9 illustrates an example procedure for multicast coordination for sensing. Consistent with embodiments described substantially in paragraphs above, a sensing initiator may transmit a message to devices at least including sensing responder 1 and sensing responder 2. Initially, upon receiving the request from the sensing initiator, sensing responder 1 and sensing responder 2 may inform the sensing initiator of their participation or non-participation in the sensing procedure by transmitting a message (e.g., along with an ACK/NACK). The sensing responders that informed the sensing initiator of their participating or sent an ACK message for the sensing procedure may form a coordinated sensing set, with the sensing initiator being the coordinator.

Subsequent procedures may ensue in the multi-cast coordination mode of sensing. As shown at 901, the sensing initiator (coordinator) may send a sensing trigger frame (also referred to as a sensing scheduler frame) to all devices that have indicated their participation in the sensing procedure as responders, or that have sent ACK messages. The trigger frame may include requested or required sensing parameters (e.g. resolution, duration, location), identifiers of the sensing responders, multiplexing types (such as time, frequency, and/or spatial multiplexing, for each sensing responder to transmit a null data packet (NDP) or joint communication and sensing PPDU (JCS-PPDU) for sensing purposes), and/or resource units in which the sensing measurements may be fed-back.

In some embodiments, the trigger frame may include a type of sensing measurement to be fed-back by a sensing responder (i.e., a sensing report (e.g. resolution, Doppler values), or sensing data samples). As shown at 902 and 904, the sensing responders may transmit NDPs as directed in the trigger frame, and/or following a short interframe space (SIFS) after receiving the trigger frame 901. The sensing responders may transmit NDPs simultaneously as coordinated by the sensing initiator via the sensing trigger frame 901. Following the NDP transmission and subsequent sensing measurements performed by each sensing responder during a sensing duration, some or all sensing responders may feedback this information to the sensing initiator as dictated in the sensing trigger frame 901. In some embodiments, the sensing report or samples transmitted by the sensing responders may be employed using backhaul wired connections, i.e., wired connections sensing initiators and sensing responders.

Solutions involving unicast coordination modes for sensing are described herein. Similarly as in the multi-cast coordination model, sensing responders that indicate their participation in sensing procedures and/or transmit acknowledgments for sensing may form a coordinated sensing set, and responder IDs may be obtained or read by the sensing initiator from, for example, the messages indicating participation, or from acknowledgement messages. Examples of methods and procedures in which the sensing initiator configures sensing responders sequentially may be carried out as follows.

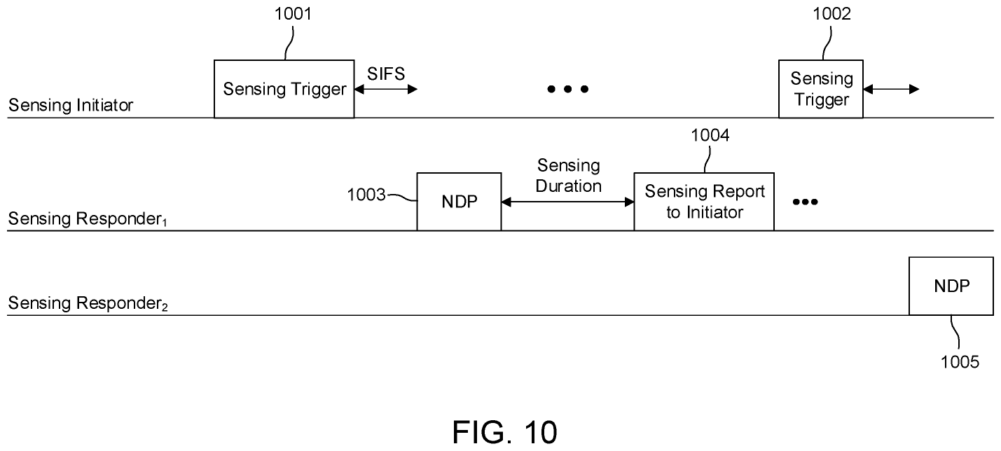

FIG. 10 illustrates an example procedure for unicast coordination for sensing. A sensing initiator (coordinator) may send sensing trigger frames sequentially in time to sensing responders 1 and 2 for sensing, shown at 1001 and 1002. The trigger frames 1001 and 1002 may include sensing requirement information (e.g. resolution, duration, location) pertaining only to a specific sensing responder, and resource units on which the sensing measurements can be fed-back to the sensing initiator. In some options, the trigger frames 1001 and 1002 may also include the type of sensing measurements to be fed-back by the sensing responder, i.e. sensing report (e.g. resolution, Doppler values), or sensing data samples. Sensing responder 1 may send an NDP 1003 as directed in the sensing trigger frame, and/or SIFS after receiving the trigger frame.

Following the NDP transmission 1003 and subsequent sensing measurement by sensing responder 1, at 1004, the sensing responder 1 may feedback the sensing measurement information (e.g., sensing report or sensing samples) to the initiator as dictated by the sensing trigger frame 1001. In some embodiments, the transmission of the sensing report or samples sent by the sensing responder may be performed using a backhaul wired connection, for example, between an initiator and responder. The process may be performed similarly for other sensing responders in different time slots. For instance, sensing responder 2 may send an NDP 1005 as directed in the sensing trigger 1002 before performing sensing measurements and sending the measurements to the sensing initiator.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

1. A method implemented in a first station (STA), the method comprising:
receiving, from a second STA, a message including information indicating a request to participate in a sensing procedure and information indicating one or more requested sensing parameters to be used for performing the sensing procedure as at least one of a transmit responder or a receive responder;
transmitting, to the second STA, in response to the received request to participate in the sensing procedure, a response message including an indication that the first STA is capable of participating in the sensing procedure using the one or more sensing parameters, the response message at least indicating that the first STA is capable of participating in the sensing procedure as a transmit responder; and
performing, using the requested sensing parameters, the sensing procedure as the transmit responder by, transmitting one or more beamformed signals.

2. The method of claim 1, wherein the response message indicates that the first STA is capable of participating as both the transmit responder and a receive responder.

3. The method of claim 2, wherein performing the sensing procedure as both the transmit responder and the receive responder comprises:
transmitting the one or more beamformed signals; and
transmitting, to the second STA, information associated with measurements of the one or more transmitted beamformed signals.

4. The method of claim 1 further comprising:
transmitting, to the second STA, responsive to the requested one or more sensing parameters, a request for additional bandwidth;
receiving, from the second STA, a message including information allocating additional bandwidth; and
transmitting the one or more beamformed signals using the allocated additional bandwidth.

5. The method of claim 1, wherein the one or more requested sensing parameters include at least one of a sensing resolution, a sensing duration, a sensing accuracy, or a presence in a given location.

6. The method of claim 3, wherein the requested sensing parameters to be used for performing the sensing procedure as the receive responder include at least one of a multiplexing type or resources for transmitting the information associated with the measurements of the one or more beamformed signals.

7. The method of claim 1, wherein the requested sensing parameters to be used for performing the sensing procedure as the transmit responder includes at least one of a beam direction, a beam identifier (ID), or a beam-refinement duration.

8. The method of claim 1, wherein a predetermined angle of arrival and departure (AoA-AoD) pattern is used when measuring the one or more beamformed signals includes to identify one or more obstacles.

9. The method of claim 1, wherein at least one of the first STA or the second STA is a non-Access Point (AP)-STA.

10. The method of claim 1, wherein at least one of the first STA or the second STA is an Access Point (AP)-STA.

11. A first station (STA) comprising:
a transceiver configured to receive, from a second STA, a message including information indicating a request to participate in a sensing procedure and information indicating one or more requested sensing parameters to be used for performing the sensing procedure as at least one of a transmit responder or a receive responder;
the transceiver configured to transmit, to the second STA, in response to the received request to participate in the sensing procedure, a response message including an indication that the first STA is capable of participating in the sensing procedure, using the one or more sensing parameters, the response message at least indicating that the first STA is capable of participating in the sensing procedure as a transmit responder; and
a processor and the transceiver configured to perform, using the requested sensing parameters, the sensing procedure as the transmit responder by, transmitting one or more beamformed signals.

12. The first STA of claim 11, where the response message indicates that the first STA is capable of participating as both the transmit responder and a receive responder.

13. The first STA of claim 12, and wherein the first STA, comprising the processor and the transceiver, is configured to perform the sensing procedure as both the transmit responder and the receive responder by:
transmitting the one or more beamformed signals; and
transmitting, to the second STA, information associated with measurements of the one or more transmitted beamformed signals.

14. The first STA of claim 11 further configured to:
transmit, to the second STA, responsive to the requested one or more sensing parameters, a request for additional bandwidth;
receive, from the second STA, a message including information allocating additional bandwidth; and
transmit the one or more beamformed signals using the allocated additional bandwidth.

15. The first STA of claim 11, wherein the one or more requested parameters include at least one of a sensing resolution, a sensing duration, a sensing accuracy, or a presence in a given location;

16. The first STA of claim 13, wherein the requested sensing parameters to be used for performing the sensing procedure as the receive responder include at least one of a multiplexing type or resources for transmitting the information associated with the measurements of the one or more beamformed signals.

17. The first STA of claim 11, wherein the information for performing the sensing procedure as a transmit responder includes at least one of a beam direction, a beam identifier (ID), or a beam-refinement duration.

18. The first STA of claim 11, wherein a predetermined angle of arrival and departure (AoA-AoD) pattern is used when measuring the one or more beamformed signals includes to identify one or more obstacles.

19. The first STA of claim 11, wherein at least one of the first STA or the second STA is a non-Access Point (AP)-STA.

20. The first STA of claim 11, wherein at least one of the first STA or the second STA is an Access Point (AP)-STA.
